(19) United States
(12) Patent Application Publication
(10) Pub. No.: US 2025/0264180 A1
(43) Pub. Date: Aug. 21, 2025

(54) PIPE AND COUPLING PROTECTION ASSEMBLY

(71) Applicants: Joshua Sullivan, Saint Helens, OR (US); Stacy Sullivan, Saint Helens, OR (US)

(72) Inventors: Joshua Sullivan, Saint Helens, OR (US); Stacy Sullivan, Saint Helens, OR (US)

(21) Appl. No.: 19/056,561

(22) Filed: Feb. 18, 2025

Related U.S. Application Data
(60) Provisional application No. 63/555,843, filed on Feb. 20, 2024.

(51) Int. Cl. F16L 55/11

(52) U.S. Cl. CPC F16L 55/11

(57) ABSTRACT

A pipe and coupling protection assembly in a pipe system. The pipe and coupling protection assembly includes, in one example, a base shroud configured to mate with a pipe coupling, a top plug mated with the base shroud, and a handle coupled to the top plug and vertically extending therefrom. In the assembly, the pipe coupling is configured to attach to a pipe stub and at least one of the base shroud and the top plug include an outer surface that tapers in a downward direction.

### CROSS-REFERENCE TO RELATED APPLICATION

The present application claims priority to U.S. Provisional Application No. 63/555,843, entitled “PIPE AND COUPLING PROTECTION ASSEMBLY”, and filed on Feb. 20, 2024. The entire contents of the above-listed application are hereby incorporated by reference for all purposes.

### FIELD

The present description relates generally to a pipe and coupling protection assembly for a pipe system.

### BACKGROUND AND SUMMARY

In certain building construction processes, plumbing systems are installed within and below concrete slabs at an early stage in the construction process. For instance, plumbing pipes may be installed in earthwork trenches and concrete slabs to provide under slab plumbing that enables above ground plumbing to be efficiently installed at later stages in construction. In these under slab plumbing layouts, stubs of the pipes protrude above the concrete slab and earthwork to enable connection and the location of the pipe to be identified for above ground plumbing installation.

The inventors have recognized several drawbacks with previous under slab plumbing layouts. For instance, during topside building construction, heavy equipment, machinery, and construction personnel move around the concrete slab in a multitude of directions, thereby increasing the chance of degradation (e.g., cracking, shearing, etc.) to the protruding pipe stubs. Repair of these pipe stubs can involve demolition of portions of the concrete slab through the use of equipment such as jackhammers and concrete saws, for instance. If pipe degradation extends into the earthwork, excavation of the soil may additionally be needed for pipe repair. For instance, earthwork may be excavated until an unbroken section of the pipe is revealed. Next the damaged pipe section is cut and debris may be removed from the unbroken pipe section. Later in the repair process, a new pipe coupling is installed, the earthwork is refilled, and a new section of concrete is poured. The new pipe again protrudes above the concrete, leaving it susceptible to equipment strikes.

Facing the aforementioned challenges, the inventors developed a pipe and coupling protection assembly to at least partially overcome the challenges. The pipe and coupling protection assembly includes, in one example, a base shroud that configured to mate with a pipe coupling that is configured to mate with a pipe stub and its coupling. The assembly further includes a top plug mated with the base shroud and a handle that is coupled to the top plug and vertically extends therefrom. Additionally, in the assembly, at least one of the base shroud and the top plug include an outer surface that tapers in a downward direction. In this way, the pipe and coupling protection assembly may be installed on a pipe and its coupling with the assembly flush with or below a concrete slab to avoid pipe degradation caused by strikes from machinery, equipment, construction personnel, and the like while allowing the assembly to be quickly identified by the handle. Further, the handle allows the top plug to be efficiently removed from the pipe stub for subsequent plumbing installation, for instance.

In one example, the pipe and coupling protection assembly may further include a sleeve that is configured to mate with an outer diameter of the pipe stub. The sleeve allows the pipe to be protected from concrete that is poured around the assembly and the pipe stub.

In another example, the base shroud may include an upper landing that is in contact with a lower side of the top plug. The upper landing allows the base shroud to support the top plug and prevents the top plug from being forced downward and wedged beyond a desirable amount when traffic drives over the top of the plug, for instance.

In another example, the pipe stub may be constructed out of metal. In such an example, the base shroud may include a tooling extension that is profiled to enable a tool to be used to tighten the pipe coupling when the upper plug is removed.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIGS. 1-2 show a first example of a pipe and coupling protection assembly.

FIG. 3 shows a detail view of a top plug that is included in the pipe and coupling protection assembly depicted in FIGS. 1-2.

FIG. 4 shows an installation sequence for the pipe and coupling protection assembly depicted in FIGS. 1-2.

FIGS. 5-6 show a second example of a pipe and coupling protection assembly.

FIGS. 7-10B show detailed view of components in the pipe and coupling protection assembly depicted in FIGS. 5-6.

FIGS. 11-12 show a third example of a pipe and coupling protection assembly.

### DETAILED DESCRIPTION

The pipe and coupling protection assemblies described herein protect pipe systems and surrounding concrete by enabling the pipe and its fittings to be placed below the striking zone of equipment and personnel that may damage the pipe and/or the fittings during certain construction phases. The pipe and coupling protection assemblies further allow for strategic timing for the piping to continue above a concrete slab, if desired. As a result, schedule delays and undesirable monetary impacts may be prevented. Further, the pipe and coupling protection assemblies additionally consistently provide a common elevation for future standard or prefabricated connections. Still further, the pipe and coupling protection assemblies enable a water tight seal in the concrete to be formed to prevent ground water seepage into the occupied building space through the use of a modular elastomer sealing system, O-rings, extruding fins, and/or hydraulic grout and a cleaner work environment with less obstructions (e.g., tripping hazards and pinch points) for all construction trades, if desired. Further, the pipe and coupling protection assemblies may be used during concrete tilt, enabling tilt panels to be poured directly over the pipe and coupling protection assembly. Consequently, the construction process is able to more efficiently unfold with less likelihood of pipe system and concrete damage. To achieve the aforementioned characteristics, the pipe and coupling protection assembly includes a base shroud that is profiled to mate with an outer diameter of a pipe stub and its coupling. The pipe and coupling protection assembly further includes a top plug that is profiled to mate with the base shroud. Additionally, a handle is coupled to the top plug to enable efficient removal of the top plug after concrete is poured around the assembly. The pipe and coupling protection assembly may further include a sleeve that cither mates with the pipe or surrounds the top plug to allow the assembly to be more easily removed from the concrete. The pipe and coupling protection assemblies described herein may be conceptually referred to as a coupling castle, in one example. In such an example, the base shroud may be referred to as a moat base and the top plug may be referred to as a battlement top.

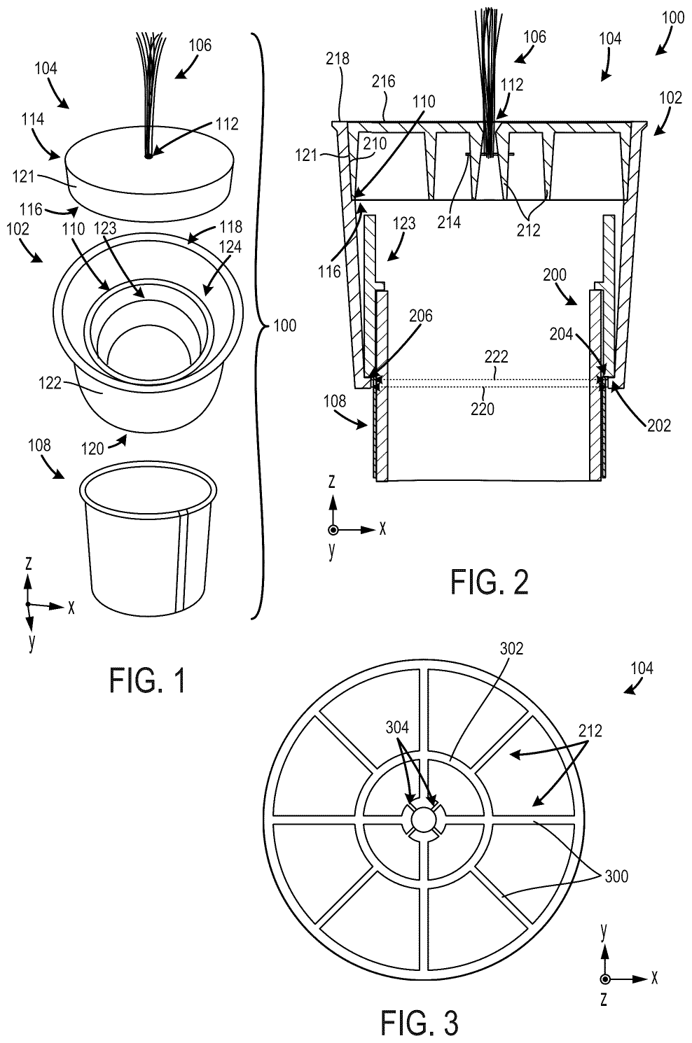

FIG. 1 shows an example of a pipe and coupling protection assembly 100. The pipe and coupling protection assembly 100 is in a disassembled configuration in FIG. 1. The pipe and coupling protection assembly 100 includes a base shroud 102 a top plug 104, and a handle 106 coupled to the top plug in the illustrated example. However, other pipe and coupling protection assembly configurations have been contemplated as elaborated upon herein.

The base shroud 102 is formed as a single piece in the illustrated example. However, the base shroud may be formed in multiple sections as discussed in greater detail herein. The pipe and coupling protection assembly 100 further includes a sleeve 108 in the illustrated example. The sleeve 108 is profiled to mate with a pipe stub as discussed in greater detail herein. However, in other examples, the sleeve may be profiled to surround the base shroud or may be omitted from the assembly in different examples.

The base shroud 102 includes an upper landing 110 that is designed to support the top plug 104 and prevents the top plug from being wedged into the base shroud when traffic drive over the top plug, for instance. The handle 106 is coupled to the top plug 104 to allow the top plug 104 to be easily removed subsequent to installation of the assembly and after concrete has been poured around the assembly and cured. The handle 106 specifically extends through an opening 112 in the top plug 104. The handle 106 also allows the location of the assembly to be quickly identified after concrete is poured around the assembly.

An outer surface 121 of the top plug 104 tapers in a downward direction, in the illustrated example. As such, a top 114 of the top plug 104 has a larger diameter than a lower side 116 of the top plug. Tapering the top plug allows the top plug to securely mate with the base shroud 102. In other examples, the top plug may not taper in a downward direction.

An outer surface 122 of the base shroud 102 tapers in a downward direction, in the illustrated example. As such, a top 118 of the base shroud 102 has a larger diameter than a bottom 120 of the base shroud. Tapering the base shroud allows the plug to be more easily removed from concrete. A pipe coupling 123 is shown mated with an inner opening 124 of the base shroud 102.

In this way, a standard pipe coupling may be efficiently installed in the assembly. Further, the top 118 of the base shroud 102 also functions to leave a breakaway surface from the concrete in cases where the concrete is over-poured and encroaches the upper surface of the top plug 104. In this way, the concrete may be more easily chipped away and removed from the top plug 104.

FIG. 2 shows a cross-sectional view of the pipe and coupling protection assembly 100 installed on a pipe stub 200. Specifically, the sleeve 108 is mated with the pipe stub 200. Next, the base shroud 102, with the pipe coupling mated therewith, is mated with the pipe stub 200. In particular, a lower side 202 of the pipe coupling 123 abuts a top lip 204 of the sleeve 108.

The tapered outer surface 121 of the top plug 104 is again depicted. In the illustrated example, the base shroud 102 includes a lower landing 206 that is in contact with the lower side 202 of the pipe coupling 123.

The top plug 104 further includes an upper landing 110 that is in contact with the lower side 116 of the top plug 104. The base shroud 102 further includes a tapered inner surface 210 that is in face sharing contact with the tapered outer surface 121 of the top plug 104.

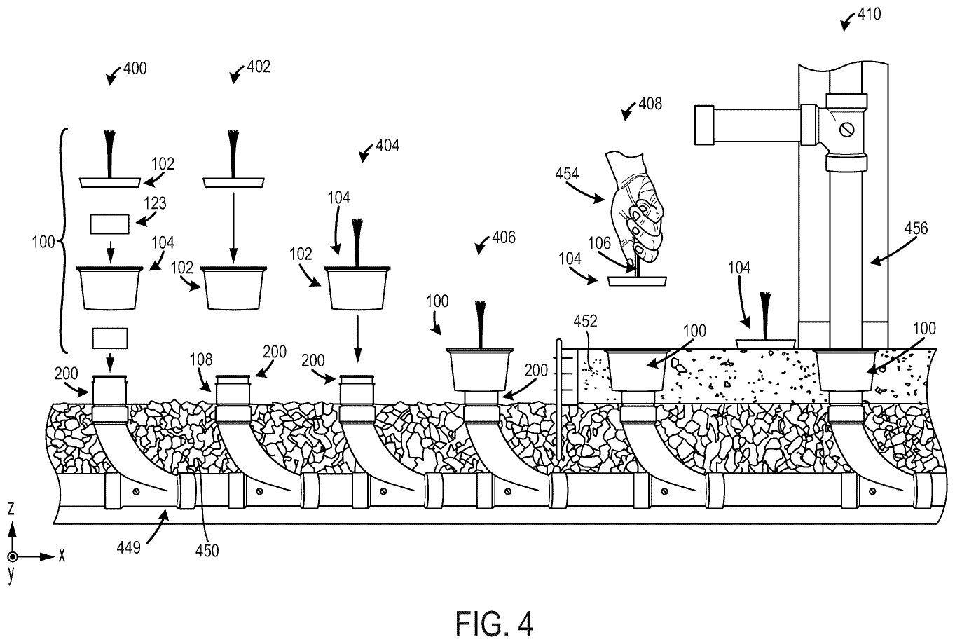

The top plug 104 additionally includes multiple walls 212. The walls are discussed in greater detail herein with regard to FIG. 3. The handle 106 shown removably attached to the top plug 104 via a keeper pin 214. However, the handle may be coupled to the top plug using other suitable techniques. Further, a top surface 216 of the top plug 104 is planar in the illustrated example. Further, the base shroud 102 may also include an upper circumferential surface 218 that aligns with the top surface 216 of the top plug 104 and may lay substantially flush with the top surface. In this way, damage to the pipe and coupling protection assembly 100 by vehicles, personnel, etc. moving around the construction zone is avoided. However, the handle 106 vertically extends through the opening 112 and above the top plug 104 to enable the location of the assembly to be identified and the top plug 104 to be effectively removed. The sleeve 108 has a cylindrical shape in the illustrated example. Thus, an outer diameter and an inner diameter of the sleeve 108 are constant along their lengths. Additionally, an outer diameter 220 of the sleeve 108 may be less than an inner diameter 222 of the lower landing 206.

FIG. 3 shows a bottom view of the top plug 104. The walls 212 of the top plug 104 are again illustrated. The walls 212 allow the structural integrity of the top plug to be increased. A portion 300 of the walls 212 are radially aligned in the illustrated example. Further, one of the walls 302 has a circular profile, in the illustrated example. Recesses 304 that are profiled to receive keeper pins are further depicted in FIG. 3. As previously discussed, the keeper pins, allow the handle to be removably attached to the top plug. However, the handle may be coupled to the top plug in another suitable manner in alternate embodiments.

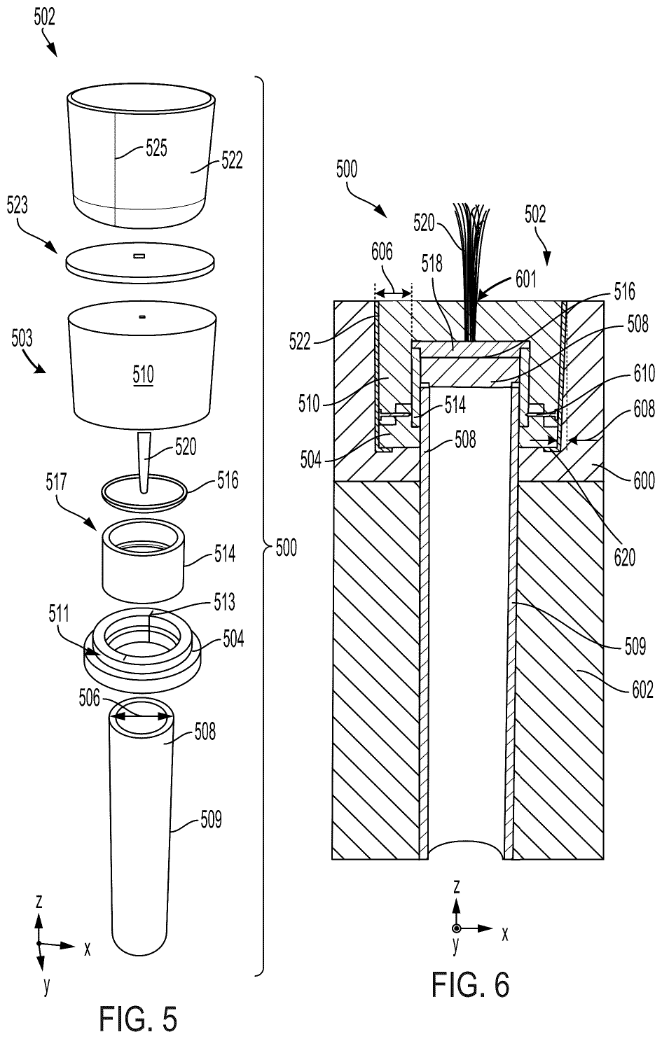

FIG. 4 shows an installation and removal sequence for the pipe and coupling protection assembly 100. It will be understood that that other pipe and coupling protection assemblies described herein may also be sequentially installed prior to concrete is poured and sequentially removed after the concrete is cured.

Steps 400, 402, 404, and 406 in the installation sequence are depicted. Further, steps 408 and 410 in the removal sequence. The pipe stub 200 is shown connected to below ground plumbing 449 in each step in both sequences. Earthwork 450 surrounds the below ground plumbing 449 in the illustrated example.

In step 400, the components in the pipe and coupling protection assembly 100 are disassembled. Specifically, the top plug 104 and the base shroud 102 are spaced away from one another in step 400.

In step 402, the pipe coupling 123, shown in step 400, is inserted into the base shroud 102 and the sleeve 108 is mated with the pipe stub 200. After this insertion, the pipe coupling 123 may then be permanently attached to the base shroud 102 via friction and/or chemical bonding. Next in step 404, the top plug 104 is mated with the base shroud 102. Next in step 406, the pipe and coupling protection assembly 100 is mated with the pipe stub 200 with the sleeve 108 mated therewith. During the mating between the assembly and the pipe stub, the assembly may then be permanently attached to the pipe stub via mechanical and/or chemical bonding.

Next in step 408, a concrete layer 452 is poured around the pipe and coupling protection assembly 100. After the concrete is poured, it is cured and it will be understood that construction machinery, construction equipment, construction personnel, and the like may move around the worksite on top of the concrete to carry out various construction tasks.

After the concrete is cured, a person 454 grips the handle 106 to remove the top plug 104 from the base shroud 102, the pipe coupling, and the pipe stub at step 408. Next in step 410, above ground plumbing 456 is attached to the pipe coupling in the pipe and coupling protection assembly 100 with the top plug 104 removed.

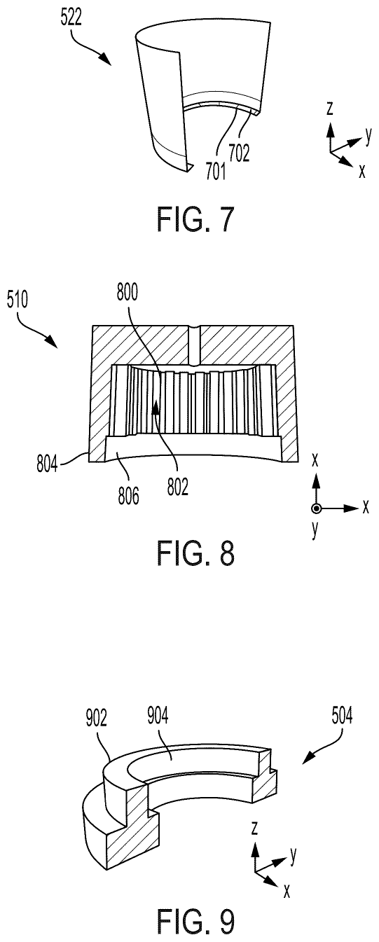

FIG. 5 shows an exploded view of a second example of a pipe system 500 which includes a pipe and coupling protection assembly 502. The pipe and coupling protection assembly 502 a base shroud 503. The base shroud 503 is formed with a two-piece construction in the illustrated example. As such, the base shroud 503 includes a lower section 504 that is profiled to mate with an outer diameter 506 of a pipe stub 508 of a pipe 509. The lower section 504 further includes an outer portion 511 that is profiled to mate and an upper section 510 of the base shroud 503.

The upper section 510 is profiled to mate with a pipe coupling 514. The pipe coupling 514 is profiled to attach to the pipe stub 508. The pipe and coupling protection assembly 502 further includes a top plug 516 that is contoured to extend across the top to the outer edges 517 and into the upper portion of the pipe coupling 514. The top plug 516 includes a handle 520 which extends vertically through a hole in the upper plug. The handle 520 may be constructed out of a flexible material which allows the handle to protrude vertically upward when installed and then bend when struck or otherwise contacted by construction machinery, equipment, personnel, and the like. The handle 520 allows the location of the pipe stub to be quickly identified without exposing an above ground section of the pipe to potential degradation caused by strikes from machinery, equipment, or personnel, for instance. The pipe and coupling protection assembly 502 may further include a sleeve 522. A traffic rated top 523 may further be included in the assembly to further protect the assembly from degradation caused by machinery, equipment, and the like which travel over the concrete after it is poured around the assembly. The traffic rated top 523 may sit on top of the upper section 510 and inside the sleeve 522. The sleeve 522 may be split from top to bottom along a line 525 which allows the sleeve to be snapped around the upper section 510 during installation, if desired. Further, the lower section 504 may include relief slits 513 to provide a breaking point if the part needs to be installed after the pipe coupling has already been glued.

FIG. 6 shows an assembled cross-sectional view of the pipe system 500 with the pipe and coupling protection assembly 502. Specifically, the lower section 504, the upper section 510, and the top plug 516 of the pipe and coupling protection assembly 502 along with the pipe coupling 514 and the pipe stub 508 of the pipe 509 are again shown. The sleeve 522 is also shown in FIG. 6. The upper section 510 is shown mated with the lower section 504 and the upper plug and the lower section enclose the pipe coupling 514. Further, the handle 520 in the top plug 516 extends through a hole 601 in the upper section 510. In this way, the handle is able to extend upward for quick pipe and coupling protection assembly identification and allows the upper plug to be rapidly vertically removed by pulling the handle upward, the handle being rigidly attached to the top plug 516 and supports the inner bottom of the upper section 510 to support the upward force when removing the handle, the cover, and the upper plug from the concrete. The traffic rated top 523 is again depicted in FIG. 6.

FIG. 6 shows the pipe system 500 incorporated into concrete 600 and earthwork 602. The concrete 600 may be in the form of a slab or serve another suitable purpose in a construction project. The lower section 504, the upper section 510, the top plug 516, the sleeve 522, and the pipe coupling 514 are again depicted. The handle 520 enables the location of the pipe system 500 to be efficiently identified by construction personnel. Further, the handle 520 may also enable a portion of the pipe and coupling protection assembly 502 which includes the upper section of the base shroud and the top plug to be quickly removed after the concrete 600 has been poured by pulling the handle upward. The top plug 516 spans and intrudes the opening 518 of the pipe coupling 514. The top plug 516 reduces the chance of (e.g., prevents) debris from entering the pipe system during construction by providing a traffic rated structure that supports the upper section 510 from caving under downward force. The top plug 516 may be constructed to prevent vertical implosion, thereby increasing the assembly's durability.

The sleeve 522 may be in the form of a split sleeve which provides a thin and slick lining between outer surfaces of the upper section 510, the lower section 504 and the inner surface of the concrete 600. In this way, the sleeve 522 may be easily removed after the concrete is poured.

The upper section 510 and the sleeve 522 may be designed with a targeted annular spacing 606 when removed from cured concrete to accept an elastomer scaling device (e.g., a hydrostatic sealing device) or poured hydraulic grout to enable a permanent ground water seal to be formed around the assembly, if desired. Exterior surfaces of the upper section 510 and the sleeve 522 may be tapered (from top to bottom) as indicated at 608. Consequently, a removal process from the concrete involving upwards motion of the parts in low friction (e.g., friction free) manner may be carried out, if desired.

The upper section 510 and the lower section 504 function in conjunction to protect the pipe coupling 514 during the concrete pouring process. To elaborate, the upper section 510 may mate with the lower section 504 to form a slurry tight seal while allowing access for future above ground piping construction. After the concrete is poured, the upper section 510 may be flush with or positioned below the upper concrete surface, thereby preventing the plug from being struck by construction equipment, machinery, personnel, and the like which move across the construction site and perform various tasks. Thus, the pipe coupling may stay in place and protect the pipe stub 508 and the pipe coupling 514 until a time is available on the job site to install above ground pipes, fixtures, and the like. The pipe coupling 514 (e.g., pipe fitting) may be standardized fittings (e.g., ASTM fittings), in one use-case example.

In one example, the pipe and coupling protection assembly 502 may be conceptually referred to as a coupling castle. In such an example, the sleeve may be referred to as a moat, the upper plug may be referred to as a battlement part, the top plug may be referred to as a draw bridge, and the lower section may be referred to as a curtain wall.

Pins 610 may be included in the pipe and coupling protection assembly to attach the upper section 510 to the lower section 504. To elaborate, the pins 610 may radially extend through the upper plug and the lower section of the base shroud. Additionally or alternatively, adhesive, caulk, and the like may be used to couple the upper plug and the lower section. In this way, the upper plug may be secured to the lower section when they are removed from the concrete using the handle, which is discussed in greater detail herein.

The sleeve 522 may have a different configuration in alternate embodiments. For instance, the sleeve 522 may be contoured such that a lower lip 620 is positioned between the upper section 510 and the lower section 504. However, in the example illustrated in FIG. 6, the lower lip 620 of the sleeve 522 wraps under the lower section 504.

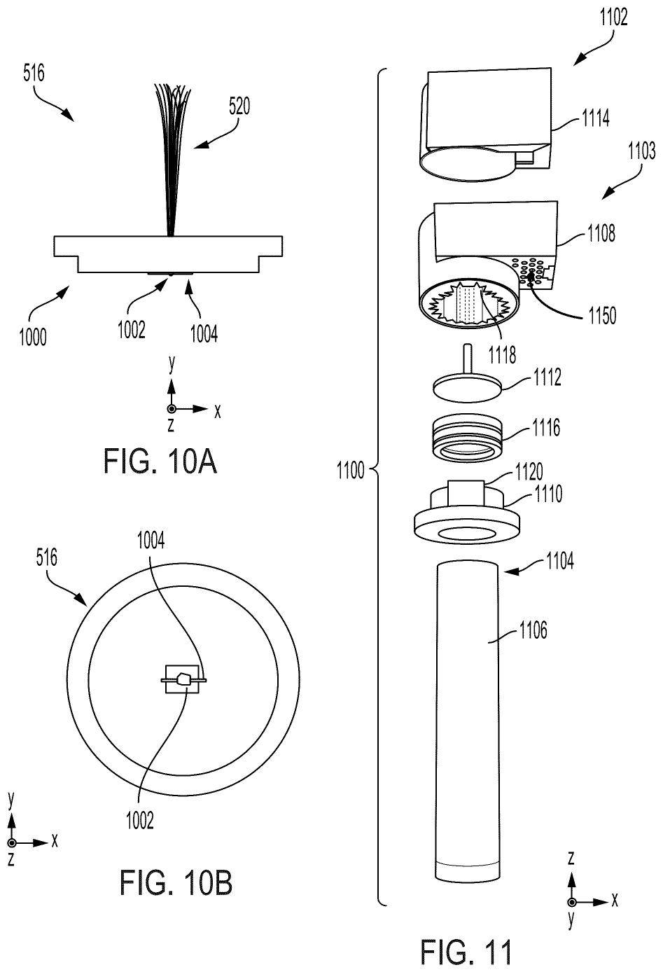

FIG. 7 shows a cross-sectional view of the sleeve 522. The sleeve may be split from top to bottom along a line which allows the sleeve to be snapped around the upper plug during installation, if desired. Further, the sleeve 522 may include relief grooves 701 in a lip 702. The relief grooves assist in opening during the installation process.

FIG. 8 shows a cross-sectional view of the upper section 510. As shown in FIG. 8, the upper section 510 may include multiple grooves 800 (e.g., vertically extending grooves) on an interior surface 802. The grooves allow the upper plug to be more quickly and efficiently removed from the concrete.

Further, the upper section 510 may include tapered side wall 804 which allows the plug to be more easily removed. However, in alternate examples, the upper plug may have a straight side wall. Still further, the upper section 510 may have an elliptical inner surface 806 that is profiled to interface with an outer surface of the lower section. The elliptical profile of the upper section 510 allows the plug to be mated with the lower section and a small turn (e.g., a 90° turn, in one use-case example) with the curtain wall part which creates friction between the upper plug and a wall of the lower section, thereby providing cohesion and a slurry tight seal for the assembly.

FIG. 9 shows different detailed views of the lower section 504. As discussed above, relief slits may be provided in the lower section 504 to provide a breaking point if the part needs to be installed after the pipe coupling has already been glued.

As shown in FIG. 9, the lower section 504 may include an elliptical outer surface 902 that is profiled to mate with the elliptical surface in the upper plug. Further, the lower section 504 may include a coping 904 for fitting with the pipe coupling. The elliptical shape of the lower section 504 as well as the upper plug, which is discussed above, allow the likelihood of the mated unit formed between the upper plug and the lower section undesirably floating in the wet concrete to be reduced.

In one example, the sleeve may be sprayed or packed with a release agent (e.g., grease, glycerin, silicone spray, and the like) prior to installation of the sleeve. In this way, the top plug and the lower section of the base shroud are able to be more easily removed after the concrete is poured around the assembly.

FIGS. 10A and 10B show different detailed views of the top plug 516. The handle 520 and the top plug 516 of the cover are again depicted. The top plug 516 includes a section 1000 that is shaped to fit within an opening of a coupling. The handle 520 may extend through the section 1000 and have a loop 1002 on a lower side of the cover. A keeper pin 1004 may extend through the loop 1002 to secure the handle in a desired manner.

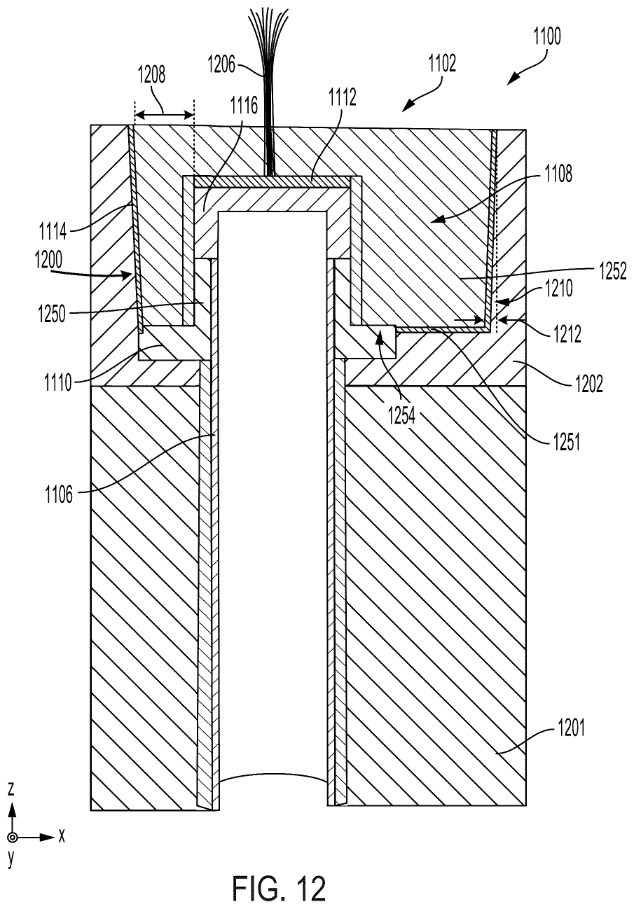

FIGS. 11 and 12 show another example of a pipe and coupling protection assembly 1102. Specifically, FIG. 11 shows an exploded view of another example of a pipe system 1100 which includes a pipe and coupling protection assembly 1102 that is designed to attach to a stub 1104 of a pipe 1106 (e.g., a metal pipe such as a cast iron pipe). The pipe and coupling protection assembly 1102 includes a base shroud 1103 and a top plug 1112. The base shroud 1103 includes an upper section 1108 and a lower section 1110. Further, in the illustrated example, the pipe and coupling protection assembly 1102 further includes a sleeve 1114. However, in alternate examples, the sleeve may be omitted from the pipe and coupling protection assembly. A rubber cap 1116 in the pipe system 1100 is further shown in FIG. 11.

In the illustrated example, the upper section 1108 includes a female key-way 1118 that mates with a male key-way 1120 in the lower section 1110 when assembled. However, the key-ways may be omitted from the upper plug and the lower section, in other examples. The upper section 1108 may include relief holes 1150.

FIG. 12 shows an assembled view of the pipe system 1100 with the pipe and coupling protection assembly 1102. Specifically, the sleeve 1114, the upper section 1108, the top plug 1112, the rubber cap 1116, the lower section 1110, and the pipe 1106 are again depicted. Exterior sides 1200 of the sleeve 1114 and the upper section 1108 may be tapered from top to bottom to allow the pipe and coupling protection assembly to be easily removed after concrete is poured around the assembly. An upper portion 1250 of the lower section 1110 mates with the upper section 1108.

FIG. 12 specifically shows the pipe system 1100 installed in earthwork 1201 and concrete 1202. The earthwork 1201 may specifically include gravel. The pipe and coupling protection assembly 1102 may have a modified upper section where an underside 1251 of a tooling extension 1252 is vertically lengthened (along the z-axis) to a lower lip 1254 of the lower section 1110. The sleeve 1114 is again depicted in FIG. 12.

The upper section 1108 includes a tooling extension 1252 that is in the form of an enlarged side. The top plug 1112 enables the upper section 1108 to be quickly removed via construction personnel by pulling a handle 1206 upward.

The sleeve 1114 may be in the form of a split sleeve which provides a slick and comparatively thin lining between the concrete 1202 and the upper section 1108. Consequently, the upper section 1108 is able to be easily removed after the concrete is poured.

The upper section 1108 may be designed with an annular spacing 1208 when removed from the cured concrete to accept a modular elastomer sealing system and/or hydraulic grout to assist in a permanent ground water seal. Exterior sides 1210 of the upper section 1108 and the sleeve 1114 are tapered as indicated at 1212 from the top to bottom to create less friction during an upward removal process from the concrete.

The upper section 1108 mates with the lower section 1110 and both surround the rubber cap 1116 to protect the pipe coupling and coupling space with a slurry tight seal which allows for access when future above ground piping construction continuation is desired. After the concrete is poured, the pipe and coupling protection assembly 1102 keeps the pipe 1106 from being struck by construction equipment, machinery, construction personnel, and the like which move across a construction site to carry out various job activities until a more viable and productive time is available with a reduced chance of pipe strike to continue above ground plumbing system construction.

It will be understood that the components in any of the pipe and coupling protection assemblies described herein may be constructed out of plastic. To elaborate, in one specific example, the top plug and the base shroud may be constructed out of acrylonitrile butadiene styrene (ABS) and the handle may be constructed out of nylon and/or latex rubber.

An axis system is provided in FIGS. 1-12, for reference. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples. FIGS. 1-12 are drawn approximately to scale. However, other relative component dimensions may be used in other embodiments.

FIGS. 1-12 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. An elements inner and outer diameter may be referred to as such. Further an element with a smaller or greater diameter or radius than another element may be referred to as such.

The invention will further be described in the following paragraphs. In one aspect, a pipe and coupling protection assembly is provided that comprises a base shroud configured to mate with a pipe coupling; wherein the pipe coupling is configured to attach to a pipe stub; a top plug coupled to the base shroud; and a handle coupled to the top plug and vertically extending therefrom; wherein at least one of the base shroud and the top plug include an outer surface that tapers in a downward direction. In one example, the pipe and coupling protection assembly may further comprise a sleeve configured to mate with an outer diameter of the pipe stub. In another example, the base shroud may include a lower landing; and an outer diameter of the sleeve may be less than an inner diameter of the lower landing. In another example, the base shroud may include an upper landing that is in contact with a lower side of the top plug. In another example, the base shroud may include a tapered inner surface. In another example, the base shroud may have a tapered outer surface with a larger circumference at a top than a bottom. In another example, the top plug may have a tapered outer surface with a larger circumference at a top than a bottom. In another example, the top plug may include a plurality of walls. In another example, at least a portion of the plurality of walls may be radially aligned. In another example, the handle may be coupled to the top plug via a keeper pin. In another example, the base shroud and the top plug may be constructed out of plastic. In another example, the top plug may be configured to remove at least a portion of the base plug when pulled vertically. In another example, the handle may be constructed out of nylon and/or latex rubber. In another example, the base shroud may include a top section and a bottom section. In another example, the top section may include a tooling extension that profiled to enable tooling access to the pipe coupling. In yet another example, the top plug may include a planar top surface.

In another aspect, a method for installation of a pipe and coupling protection assembly is provided that comprises installing a base shroud onto a pipe stub; and installing a top plug within the base shroud; wherein at least one of the top plug and the base shroud is tapered in a downward direction; and wherein a handle is coupled to the top plug and vertically extends therefrom. In one example, the method may further comprise, prior to installing the base shroud onto the pipe stub, installing a sleeve on the pipe stub. In another example, the method may further comprise removing the top plug via pulling the handle upwards. In yet another example, the handle may be coupled to the top plug via a keeper pin. In another example, both of the top plug and the base shroud include a tapered outer surface with a larger circumference at a top than a bottom.

It will be appreciated that the configurations and routines disclosed herein are exemplary in nature, and that these specific embodiments are not to be considered in a limiting sense, because numerous variations are possible. For example, the above technology can be applied to a broad range of construction environments. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A pipe and coupling protection assembly, comprising:
a base shroud configured to mate with a pipe coupling;
wherein the pipe coupling is configured to attach to a pipe stub;
a top plug mated with the base shroud; and
a handle coupled to the top plug and vertically extending therefrom;
wherein at least one of the base shroud and the top plug include an outer surface that tapers in a downward direction.

2. The pipe and coupling protection assembly of claim 1, further comprising a sleeve configured to mate with an outer diameter of the pipe stub.

3. The pipe and coupling protection assembly of claim 2, wherein:
the base shroud includes a lower landing; and
an outer diameter of the sleeve is less than an inner diameter of the lower landing.

4. The pipe and coupling protection assembly of claim 1, wherein the base shroud includes an upper landing that is in contact with a lower side of the top plug.

5. The pipe and coupling protection assembly of claim 1, wherein the base shroud includes a tapered inner surface.

6. The pipe and coupling protection assembly of claim 1, wherein the base shroud has a tapered outer surface with a larger circumference at a top than a bottom.

7. The pipe and coupling protection assembly of claim 6, wherein the top plug has a tapered outer surface with a larger circumference at a top than a bottom.

8. The pipe and coupling protection assembly of claim 1, wherein the top plug includes a plurality of walls.

9. The pipe and coupling protection assembly of claim 8, wherein at least a portion of the plurality of walls are radially aligned.

10. The pipe and coupling protection assembly of claim 1, wherein the handle is coupled to the top plug via a keeper pin.

11. The pipe and coupling protection assembly of claim 1, wherein the base shroud and the top plug are constructed out of plastic.

12. The pipe and coupling protection assembly of claim 1, wherein the top plug is configured to remove at least a portion of the base plug when pulled vertically.

13. The pipe and coupling protection assembly of claim 1, wherein the base shroud includes a top section and a bottom section.

14. The pipe and coupling protection assembly of claim 13, wherein the top section includes a tooling extension that is profiled to enable tooling access to the pipe coupling.

15. The pipe and coupling protection assembly of claim 1, wherein the top plug includes a planar top surface.

16. A method for installation of a pipe and coupling protection assembly, comprising:
installing a base shroud onto a pipe stub, wherein a pipe coupling is mated with the base shroud; and
installing a top plug within the base shroud;
wherein at least one of the top plug and the base shroud is tapered in a downward direction; and
wherein a handle is coupled to the top plug and vertically extends therefrom.

17. The method of claim 16, further comprising, prior to installing the base shroud onto the pipe stub, installing a sleeve on the pipe stub.

18. The method of claim 16, further comprising removing the top plug via pulling the handle upwards.

19. The method of claim 16, wherein the handle is coupled to the top plug via a keeper pin.

20. The method of claim 16, wherein both of the top plug and the base shroud include a tapered outer surface with a larger circumference at a top than a bottom.
